(19) United States
(12) Patent Application Publication
(10) Pub. No.: US 2010/0155611 A1
(43) Pub. Date: Jun. 24, 2010

(54) RADIATION-DETECTING STRUCTURES

(75) Inventors: Clayton Fullwood, Austin, TX (US); Timothy Z. Hossain, Austin, TX (US); Patrick Mark Clopton, Austin, TX (US); Roberto Colecchia, San Jose, CA (US); Richard Blish, Saratoga, CA (US)

Correspondence Address: LARSON NEWMAN & ABEL, LLP, 5914 W. COURTYARD DRIVE, SUITE 200, AUSTIN, TX, 78730, US

(73) Assignee: SPANSION LLC, Sunnyvale, CA (US)

(21) Appl. No.: 12/340,295

(22) Filed: Dec. 19, 2008

(51) Int. Cl. G01T 3/08; G01T 3/00

(52) U.S. Cl. 250/370.05; 250/390.01

(57) ABSTRACT

A mobile device including a housing, a wireless signal transceiver contained within the housing, and a radiation-detecting structure comprising a charge storage structure contained within the housing to detect radiation.

### CROSS-REFERENCE TO RELATED APPLICATION(S)

The following disclosure is a non-provisional application which claims priority to U.S. Provisional Application No. 60/060,001 filed Jun. 9, 2008, entitled “Imaging Device” and having named inventors Timothy Z. Hossain, which application is incorporated by reference herein in its entirety.

### BACKGROUND

1. Field of the Disclosure

The following application is directed to radiation-detecting devices, and more particularly radiation-detecting devices incorporating charge storage structures.

2. Description of the Related Art

Radiation-detecting devices can be used to detect certain types of radiation, however, some may be particularly expensive and cumbersome. For example, conventional neutron detectors generally include a container including a neutron sensitive gas, such as ³He or BF₃, and an electrically charged wire having leads which extend outside of the container. In operation, incident neutrons react with the gas to produce charged particles which change the electrical potential of the wire. A measurement system coupled to the charged wire measures the electrical pulses and uses this information to indicate the presence of neutrons. These types of neutrons detectors are undesirably bulky and are associated with poor sensitivity resulting from, for example, electronic noise.

### BRIEF DESCRIPTION OF THE DRAWINGS

The present disclosure may be better understood, and its numerous features and advantages made apparent to those skilled in the art by referencing the accompanying drawings.

FIG. 1 includes a cross-sectional illustration of a portion of a radiation-detecting device including a radiation-detecting structure in accordance with an embodiment.

FIG. 2 includes a cross-sectional illustration of a portion of a radiation-detecting device including a radiation-detecting structure in accordance with an embodiment.

FIG. 3 includes a cross-sectional illustration of a portion of a radiation-detecting device including a radiation-detecting structure in accordance with an embodiment.

FIG. 4 includes a cross-sectional illustration of a portion of a radiation-detecting device including a radiation-detecting structure in accordance with an embodiment.

FIG. 5 includes a cross-sectional illustration of a portion of a radiation-detecting device including a radiation-detecting structure in accordance with an embodiment.

FIG. 6 includes a cross-sectional illustration of a portion of a radiation-detecting device including a radiation-detecting structure in accordance with an embodiment.

FIG. 7 includes a cross-sectional illustration of a portion of a radiation-detecting device including a radiation-detecting structure in accordance with an embodiment.

FIG. 8 includes a cross-sectional illustration of a device including a plurality of radiation-detecting components in accordance with an embodiment.

FIG. 9A includes a schematic block diagram of a portion of a radiation-detecting device including a radiation-detecting structure including an array of charge storage structures in accordance with an embodiment.

FIG. 9B includes a schematic block diagram of a portion of a radiation-detecting device and a radiation-insensitive device in accordance with an embodiment.

FIG. 10 includes a block diagram illustration of a mobile device including a radiation detecting device including a radiation-detecting structure in accordance with an embodiment.

FIG. 11 includes an illustration of a geographic region including a communication network for managing data of radiation-detecting devices in accordance with an embodiment.

FIG. 12 includes an illustration of a transportation vehicle including a radiation-detecting device in accordance with an embodiment.

The use of the same reference symbols in different drawings indicates similar or identical items.

### DETAILED DESCRIPTION

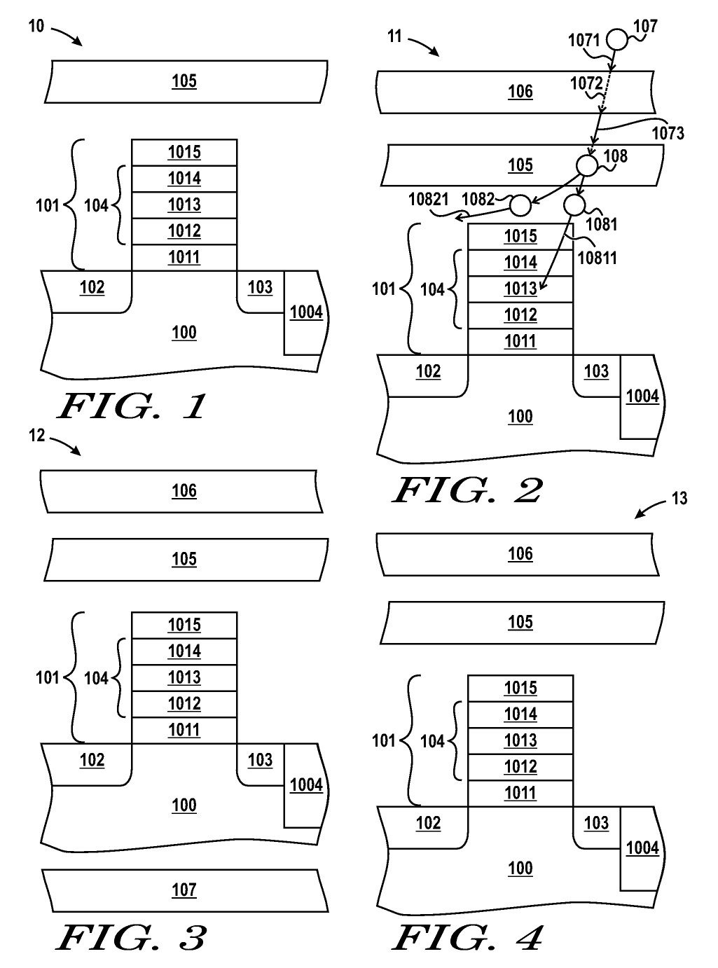

FIG. 1 includes a cross-sectional illustration of a portion of a radiation detecting device 10 that includes a radiation-detecting structure that can be used in accordance with an embodiment to detect radiation. As illustrated, the radiation detecting device 10 includes a substrate 100, generally suitable for supporting components. The substrate 100 can include a semiconductor material or insulative material, or any combination thereof. For example, the workpiece can include a monocrystalline semiconductor wafer, semiconductor-on-insulator (SOI) wafer, a flat panel display (e.g., a silicon layer over a glass plate), or other substrates conventionally used to form electronic devices. In accordance with a particular embodiment, the substrate 100 is made of a single crystal material, such as a single crystal silicon wafer. Furthermore, the substrate 100 can include a dopant, such as including a n-type or p-type dopant. Substrate 100 can include electronic components or portions of electronic components previously formed thereon, including for example, implant regions, field isolation regions, or other layers used to form electronic components.

According to one embodiment, the substrate 100 can include a semiconductor material. Some suitable semiconductor materials can include elements selected from Groups 13, 14, and 15 of the Periodic Table according to the new IUPAC format. For example, certain semiconductive materials can include silicon, germanium, arsenic, gallium, indium, carbon, a combination thereof, and the like.

As further illustrated in FIG. 1, the device 10 includes a stack 101 made of a plurality of layers overlying the substrate 100. The stack 101 represents a structure suitable for storing charges, for example, it may be a transistor gate stack having a charge storage structure. As illustrated, the stack 101 includes a layer 1011 disposed directly overlying and abutting an upper surface of the substrate 100. In accordance with a particular embodiment, layer 1011 includes a dielectric material. Suitable dielectric materials can include oxides, nitrides, and combinations thereof. In accordance with a particular embodiment, the layer 1011 includes silicon dioxide. Layer 1011 can be formed by growth techniques, deposition techniques, and the like.

As further illustrated in FIG. 1, the stack 101 includes a charge storage structure 104 overlying the substrate 100. Notably, the charge storage structure 104 includes a plurality of layers, particularly layers 1012, 1013, and 1014. It will be appreciated that the charge storage structure 104 facilitates the storage of charge therein, and thereby facilitates storage of data. Additionally, as illustrated in this particular embodiment, layers 1012, 1013, and 1014 are in direct contact with each other (i.e., abutting).

The charge storage structure 104 includes layer 1012 overlying and abutting layer 1011. In accordance with an embodiment, layer 1012 can include a dielectric material, such as those described in accordance with layer 1011. For example, layer 1012 can include silicon dioxide. Layer 1012 and layer 1011 can be distinct and separately formed layers, such as a native oxide layer 1011 and a thermally grown oxide layer 1012. Alternatively, it will be appreciated that layers 1012 and 1011 can be different regions of a commonly formed layer. Layer 1012 can be formed by growth techniques, deposition techniques, and the like.

The charge storage structure 104 further includes a layer 1013 overlying and abutting layer 1012. In accordance with an embodiment, layer 1013 includes a conductive material, such as a metal. According to an alternative embodiment, layer 1013 includes a non-conductive material, such as a nitride material. Other features of layer 1013 will be discussed in more detail herein. Layer 1013 can be formed by growth techniques, deposition techniques, and the like

The charge storage structure 104 further includes layer 1014 overlying and abutting layer 1013. The layer 1014 can include a dielectric material such as those discussed in accordance with layer 1012. Layer 1014 can be formed by growth techniques, deposition techniques, and the like.

As further illustrated in FIG. 1, the device 10 includes a layer 1015 overlying the charge storage structure 104. Layer 1015 can include a semiconductive material, a metal, and the like. Suitable semiconductive materials can include silicon, germanium, gallium, or a combination thereof. In accordance with one particular embodiment, the layer 1015 includes a doped polysilicon.

The device 10 of FIG. 1 further includes a layer 105 overlying the charge storage structure 104 and the substrate 100. In accordance with a particular embodiment, the layer 105 is a radiation-reactive upper layer. As used herein, the term “radiation-reactive” refers to a layer or material having a high probability of interacting with radiation to generate or spawn a charged particle or photon. For example, one such radiation-reactive material is a material that includes boron-10 (¹⁰B), which is an element having a high probability of interacting with radiated neutrons and spawning an alpha particle and a lithium-7 (⁷Li) particle upon interacting with a neutron. In contrast, other forms of boron, such as boron-11 (¹¹B), are not radiation-reactive, as such elements do not have a tendency to interact with radiated neutrons. Accordingly, materials or layers that include a radiation-reactive material include radiation-reactive elements such as boron-10 (¹⁰B), lithium-6 (⁶Li), cadmium-113 (¹¹³Cd), and gadolinium-157 (¹⁵⁷Gd), (OK) or a combination thereof. Additionally, layers including radiation-reactive materials may be in the form of compounds, for example inorganic compounds, such as carbides, nitrides, borides, oxides, silicides, oxynitrides, and a combination thereof. According to one embodiment, layer 105 includes a boron-10 compound such as boron nitride or boron carbide. In an alternative embodiment, layer 105 includes lithium nitride including lithium-6 atoms.

In certain embodiments, the radiation-reactive material can be included in an amorphous material. For example, the radiation-reactive material can be incorporated in a glass material. In one particular embodiment, the radiation-reactive material includes borophosphosilicate glass material.

In accordance with an embodiment, layer 105 is a radiation-reactive layer including a radiation-reactive material. For example, according to a particular embodiment, layer 105 includes boron. In accordance with more particular embodiments, layer 105 can include a certain percentage of boron, such that at least about 5% of the boron atoms within the layer are boron-10 atoms. Still, in other embodiments the total percentage of boron-10 atoms of all boron atoms within layer 105 can be greater, such as at least about 10%, at least about 25%, or at least about 50%. Still, particular embodiments may contain a percentage of boron-10 atoms that is not greater than about 80% of the total boron atoms present within layer 105, such as about 75%, 65%, or 60% based upon the sensitivity of the device and the intended application. Notably, other instances may have a percentage of boron-10 atoms within layer 105 that is greater than about 80% of the total boron atoms present within layer 105.

Layer 105 can have an average thickness that is at least about 3 microns, particularly in those application using boron-10. In other embodiments, the average thickness of layer 105 can be greater, such as at least about 5 microns, at least about 8 microns, 10 microns, 15 microns or even at least about 20 microns. In accordance with a particular embodiment, the average thickness of layer 105 is within a range between about 3 microns and about 20 microns, and even more particularly between about 5 microns and about 15 microns.

Notably, certain materials may be more suitable for use with thicker layers, for example lithium, (i.e., lithium-6), which may be more useful in layers having thicknesses exceeding 10 microns, such as at least about 15 microns, 20 microns. In certain embodiments, the thickness of certain lithium-6 containing layers is within a range between about 10 microns and about 30 microns.

Referring again to the charge storage structure 104, as described previously, layer 1013 can include a charge storage material such as silicon nitride. Still, in other particular embodiments, the layer 1013 can include a radiation-reactive material such as that described in accordance with layer 105. For example, according to an embodiment, a material of layer 1013 includes boron, for example boron nitride, where a concentration of the boron is boron-10. As discussed above in accordance with layer 105, layer 1013 can include certain concentrations of boron-10 atoms as identified above.

While reference to the charge storage structure 104 has been made, wherein layer 1013 can be made of a non-conductive material, such as silicon nitride, it will be appreciated, in other embodiments the charge storage structure 104 can incorporate a conductive layer. For example, the charge storage structure can include an isolated conductive layer, such as a metal-containing layer. Moreover, while the embodiment of FIG. 2 has illustrated a charge storage structure 104 as part of a transistor stack, it will be appreciated that in other embodiments charge storage structures need not be incorporated as part of a transistor stack.

As such, the average thickness of the layer 1013 can be within a range between about 1 nm and about 500 nm, such as within a range between about 2 nm and about 250 nm, or even more particularly within a range between about 10 nm and about 100 nm.

FIG. 1 further illustrates regions 102 and 103 within the substrate 100 and underlying portions of the stack 101. In accordance with a particular embodiment, regions 102 and 103 can be implant regions within the substrate 100 suitable for allowing flow of electrons through a transistor that is associated with the stack 101. In accordance with a particular embodiment, regions 102 and 103 can be doped source/drain regions, including a n-type or p-type dopant material. In more particular instances, regions 102 and 103 can include a radiation-reactive material. For example, in accordance with on embodiment, the regions 102 and 103 include boron-10. The region directly underlying the stack 101 is a channel region that can be doped to have the opposite conductivity-type as the source drain regions.

As will be appreciated, the referenced radiation-detecting structure of the device 10 can include the substrate 100, the source/drain regions 102 and 103 and channel region within the substrate 100, the stack 101, and layer 105 as described above. As used throughout the subsequent description, a radiation-detecting structure will be generally be understood to incorporate similar elements unless otherwise stated. It will be appreciated that other elements may be considered part of the radiation-detecting structure, for example, other regions, structures, and components that are used to detect the occurrence of a radiation event.

FIG. 1 further illustrates region 1004 within the substrate 100 adjacent to, and in particular, abutting region 103. In one particular instance, region 1004 can be a field isolation region suitable for electrically insulating the source drain region 103 from other adjacent source/drain regions, for example separation of multiple transistors disposed at the substrate 100. In accordance with one embodiment, the region 1004 can include a radiation-reactive material. For example, in certain embodiments, the region 1004 can include a dielectric compound including the radiation-reactive material such as boron nitride, boron carbide, or lithium nitride.

FIG. 2 includes a cross-sectional illustration of a portion of a radiation detecting device 11 including a radiation-detecting structure in accordance with an embodiment. The device 11 includes a radiation-detecting structure similar to that described at FIG. 1 with the addition of layer 106 overlying layer 105. In particular, the radiation-detecting structure includes the elements previously identified and the layer 106.

As further illustrated in FIG. 2, the radiation-detecting structure of device 11 includes a layer 106 overlying layer 105 that represents a thermalizing material. As used herein, reference to a “thermalizing material” is reference to a material capable of slowing down a particular type of radiation, thus making it more apt to be detected by the radiation-detecting structure. For example, with respect to neutron radiation, suitable thermalizing materials can include hydrogen-containing materials, deuterium-containing material, and carbon-containing materials. In some instances, such thermalizing materials may be combined with other materials such as metals, ceramics, polymers, or combinations thereof. For example, the thermalizing material can be a polymer material such as polyolefins, polyamids, polyimids, polyesters, polystyrenes, polycarbonates, polyurethanes, polyethers, polysulphones, polyvinyls, and polyactic acids, or combinations thereof.

In particular embodiments, layer 106 can be a polymer containing a minimum amount of a deuterium-containing material, such as at least about 1 wt % deuterium. Other embodiments, may contain a greater content of the deuterium-containing material assuring suitable reduced speeds for the incoming radiation. As such, the polymer can contain at least 10 wt % deuterium, or even at least about 15 wt % deuterium. Still, particular embodiments utilizing a minority amount of the deuterium-containing material such that it is within a range between about 1 wt % and about 20 wt %.

FIG. 2 further illustrates a thermalizing event with respect to a particle 107. In accordance with a particular embodiment, particle 107 can include a neutron particle traveling on a path 1071 towards layer 106. Upon striking and interacting with layer 106, the neutron particle 107 is slowed, i.e., thermalized, and has a path 1072 through the layer 106 containing the thermalizing material. Upon slowing of the neutron particle 107, it exits layer 106 and travels along path 1073 towards the layer 105, which according to embodiments herein, contains a radiation-reactive material. Upon striking the layer 105 containing the radiation-reactive material, such as boron-10, the particle 107, e.g., a neutron, reacts with the boron-10 atom 108 and the resulting reaction generates two particles 1082 and 1081 that exit the layer 105 upon paths 10821 and 10811.

In particular reference to neutron particles, during such a reaction with boron-10, the interaction between the neutron particle 107 and boron-10 atom 108 results in the generation of an alpha particle and a lithium-7 particle. The emitted particles 1082 and 1081 that result from the interaction of the neutron particle 107 with the boron-10 atom 108 can cause a modification of the charge stored within charge storage structure 104, which can be detected as a change of a charge storage state. In one embodiment, a charge-detecting device detects a change of the charge storage state as a change in conductive state of a transistor associated with the charge storage structure that has had its charge modified. In particular, it is thought that the generation of a particle/or photon 1081 extending along path 10811, as illustrated in FIG. 3, interacts with the material of the charge storage structure 104 to cause a change of state.

In further reference to FIG. 2, in accordance with a particular embodiment, the layer 106 includes a thermalizing material as described herein. In certain other embodiments, other layers within the radiation-detecting structure 11 can include thermalizing materials. For instance, a portion of the charge storage structure 104 can include a thermalizing material. Suitable layers within the charge storage structure containing the thermalizing material can include dielectric layers, such as 1014 and 1012. In accordance with one particular embodiment, the dielectric layers 1014 and 1012 may be particularly suited to include a thermalizing material such as deuterium. For example, formation of such layers may be carried out such that the reactants (e.g., Silane™) include the thermalizing material such as deuterium, such that when the layers 1012 and 1014 are formed, they naturally include the thermalizing material.

FIG. 3 includes a cross-sectional illustration of a portion of a radiation detecting device 12 including a radiation-detecting structure in accordance with an embodiment. In particular, FIG. 3 illustrates substantially the same radiation-detecting structure as illustrated in FIG. 2 with the addition of layer 107. According to an embodiment, layer 107 can include a thermalizing material, such as those previously described in accordance with layer 106. Layer 107 facilitates thermalization of radiation from above and below the charge storage region 104, improving the probability that non-thermalized radiation will be detected. Moreover, according to a particular embodiment, the charge storage structure 104 can be sealed within the thermalizing material. For example, in a more particular embodiment, the charge storage structure is hermetically sealed within thermalizing material such that it is not exposed to an ambient environment.

It will be appreciated that the thermalizing layer can be incorporated as a film within the device, more particularly as a layer having dimensions (e.g., thickness) of a micrometer or less. Such a layer can be integrated within the microelectronic device, by a deposition or growth process. Alternatively, the thermalizing layer can be a macroscopic layer, having larger proportions and incorporated as part of an application-specific structure or final-formed device.

FIG. 4 includes a cross-sectional illustration of a portion of a radiation device 13 including a radiation-detecting structure in accordance with an embodiment. In accordance with a particular embodiment, the device 13 can be formed such that it is sensitive to multiple types of radiation. For example, the device 13 includes multiple layers of radiation-reactive materials, each layer reactive to different types of radiation, and wherein each of the layers are associated with a single radiation-detecting structure. Accordingly, as illustrated in FIG. 4, the device 13 includes radiation-detecting structures similar to that described in FIG. 1 and includes a layer 109 overlying layer 105 that includes a radiation-reactive material sensitive to a different type of radiation than that of layer 105. For example, in accordance with one embodiment, layer 105 may include a radiation-reactive material that is sensitive to neutrons, and as such includes boron-10, while layer 109 includes a radiation-reactive material that is sensitive to a different type radiation, such as gamma ray radiation, and accordingly may include a different material that than in layer 105, such as lead or gadolinium.

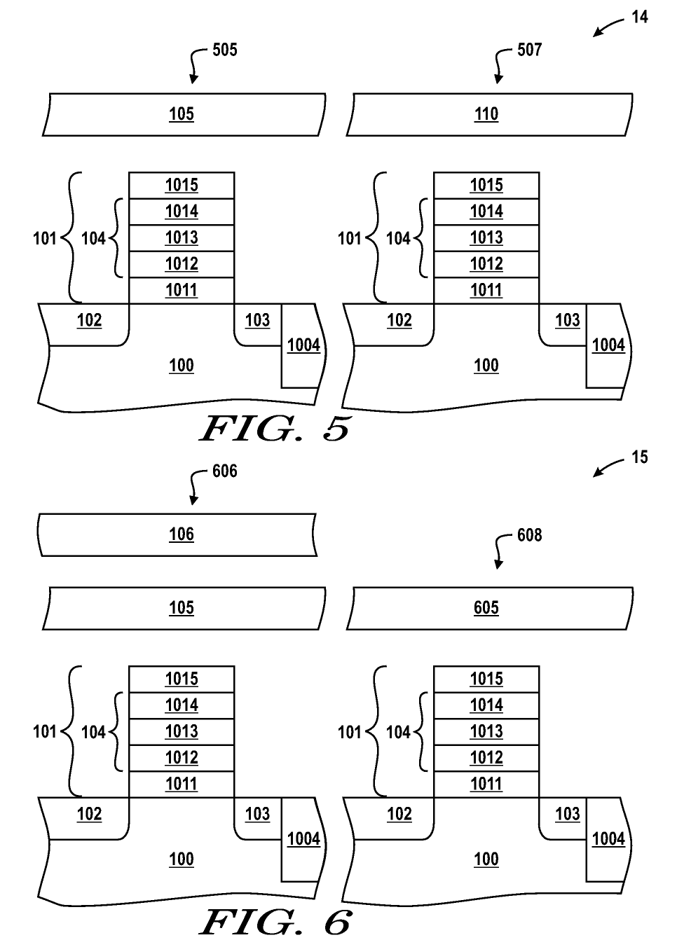

FIG. 5 includes a cross-sectional illustration of a portion of a radiation detecting device 14 that includes a radiation detecting structure. Notably, the radiation-detecting structure includes a first radiation-detecting portion 505 and a second radiation-detecting portion 507 separate and spaced apart from the first radiation detecting portion 505. The second radiation-detecting portion 507 includes elements identified with the radiation-detecting structure of FIG. 1 and additionally includes a second set of similarly numbered elements and a layer 110.

In accordance with a particular embodiment, the first radiation-detecting portion 505 has a charge storage structure 104 associated with layer 105 that includes a radiation-reactive material sensitive to a first radiation type. The second radiation-detecting portion 507 includes a second charge storage structure 504 associated with a layer 110, including a second radiation-reactive material sensitive to a second radiation type. Such a configuration facilitates the detection and reaction of components within the same substrate to multiple forms of radiation, including for example, neutron particles, gamma ray radiation, x-ray radiation, and other types of radiation and subatomic particles.

Accordingly, it will be noted that FIG. 4 illustrates a portion of a radiation-detecting device having a single stack associated with multiple radiation-reactive materials, while FIG. 5 illustrates an alternative embodiment, in which a portion of a radiation-detecting device includes two distinct and different associated portions (i.e., stacks), such that each portion is sensitive to a different radiation type. With regard to the later, such a configuration may be advantageous when an array of stacks are disposed at a single substrate.

FIG. 6 includes a cross-sectional illustration of a portion of a radiation detecting device 15 including a radiation-detecting structure in accordance with an embodiment. In particular, the device 15 includes a first radiation-detecting portion 606 and a second radiation-detecting portion 608 spaced apart from the first radiation-detecting portion 606, wherein each portion is associated with two separate radiation-detecting structures similar to that described at FIG. 5, with layer 110 excluded from the second radiation-detecting portion 608. The second radiation-detecting portion 608 includes the same regions and layers as the radiation-detecting structure described in FIG. 1. Notably, the first radiation-detecting portion 606 includes layer 106 overlying layer 105, which as previously described, can include a thermalizing material. The second radiation-detecting portion 608 includes an overlying layer 605, which can include a radiation-reactive material, but does not include a second overlying layer having thermalizing material, as associated with the first radiation-detecting portion 606. As such, the second radiation-detecting portion 608 is exposed to the environment external to the thermalizing material. Accordingly, the first radiation-detecting portion 606 will be more capable of detecting higher energy radiation particles as opposed to the second radiation-detecting portion 608 since it utilizes the thermalizing material within layer 106.

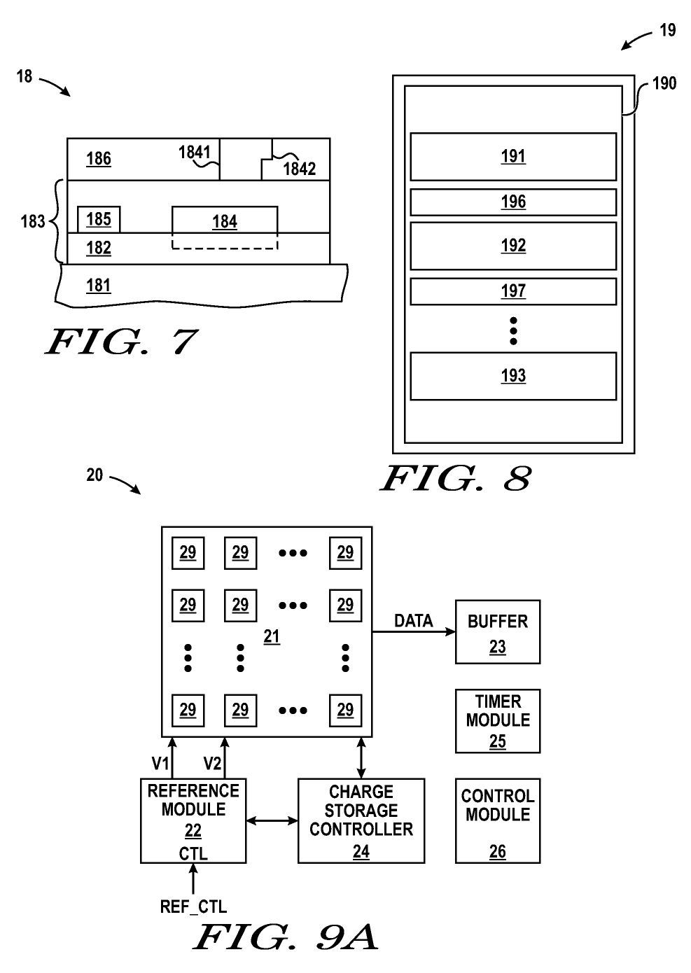

FIG. 7 includes a cross-sectional illustration of a portion of a radiation detecting device 18 including a radiation-detecting structure in accordance with an embodiment. In particular, FIG. 7 illustrates a radiation-detecting device 18 that includes a base 181, a substrate 182 overlying the base 181, where the substrate 182 is part of an integrated circuit device 183. The integrated circuit 183 further includes a logic circuit 185 electrically coupled to the radiation-detecting structure 184. A cover 186 overlies the radiation-detecting structure 184.

The base 181 provides a rigid support suitable for the integrated circuit 183, and particularly the substrate 182. As such, the base 181 can include a metal, polymer, or ceramic material. In accordance with one embodiment, the base 181 includes a ceramic material such as an oxide, carbide, nitride, boride, or a combination thereof. In accordance with another embodiment, the base 181 can include a radiation-absorbing material, more particularly a neutron-absorbing material. As such, suitable neutron-absorbing materials can include metals, such as cadmium or gadolinium.

The base 181 can further be configured such that it has a size that is greater than that of the substrate 182. For example, the base 181 can have a diameter and thickness greater than that of the substrate 182 and the integrated circuit 183. Additionally, while not illustrated in the embodiment of FIG. 7, the base 181 can be shaped such that it covers and can be in direct contact with a majority of the external surface area of the substrate 182. For example, in one certain embodiment the base 181 wraps around the sides of the substrate 182. In another particular embodiment, the substrate 182 can be disposed within an interior space within the base 181, such that the substrate 182 is recessed within an opening in the base 181.

The substrate 182 can provide a support suitable for formation of the radiation-detecting structure 184 thereon. In accordance with an embodiment, the substrate can include a semiconductor material as described herein. For example, in certain instances, substrate can include a single crystal material, such that in certain instances the substrate 182 can be an entire single crystal wafer used in processing microelectronic devices, or a portion of an entire single crystal layer. In one particular embodiment, the substrate 182 is a semiconductor-on-insulator material, or bulk semiconductor material. According to an alternative embodiment, the substrate 182 can include an amorphous material, such that it can be a glass, and more particularly a glass panel, such as used in the LCD display industry.

Generally, the substrate 182 has a size sufficient to hold the structures thereon. As such, according to one embodiment, the substrate 182 can have a diameter of at least about 10 cm. In other embodiments, the substrate 182 has a greater diameter, such as at least about 15 cm, at least about 20 cm, and more particularly within a range between about 10 cm and about 60 cm.

In further reference to the geometry of the substrate 182, generally the substrate 182 has a thickness such that it is sufficiently rigid and strong to be mounted on the base 181 and support the radiation-detecting structure 184. As such, in one embodiment, the substrate has an average thickness of at least about 0.5 mm. In other embodiments, the substrate has a thickness that is on the order of at least about 0.75 mm, at least about 1 mm, at least about 3 mm, and particularly within a range between about 0.5 mm and about 5 mm, such that in certain particular embodiments the substrate can be an unpolished wafer.

The radiation-detecting structure 184 is disposed at the substrate 182. In particular, the radiation-detecting structure 184 can include a memory array and having an array of charge storage structures. Notably, the radiation-detecting structure 184 can include features previously described and illustrated in FIGS. 1-6. In particular, the radiation-detecting structure 184 can include an array of charge storage structures, wherein each of the charge storage structures can include those components illustrated in FIG. 1. In accordance with a particular embodiment, the device 18 can include an array of charge storage structures such as not less than about 100 charge storage structures. Other embodiments may utilize more, such as not less than about 200, not less than 300, or even not less than 500 charge storage structures.

In certain embodiments, the electronic device 18 may have a housing that holds more than one radiation-detecting structure 184. In fact, the housing can include a chip (i.e., semiconductor die) wherein each semiconductor die contains at least one array of radiation-detecting structures in the form of charge storage structures. In such embodiments, the housing can include more than one semiconductor die to increase the sensitivity of the device and improve the opacity of the electronic components to certain types of radiation. According to one embodiment, such electronic components can include at least about 3 semiconductor dice, or at least about 5 semiconductor dice, or even at least about 6 semiconductor dice within the housing. Generally, the number of semiconductor dice within an electronic components is not greater than about 10, and more particularly, within a range between 5 and 8 semiconductor dice (each semiconductor die containing a single memory array of radiation-detecting structures) since the sensitivity may not necessarily be increased with more semiconductor dice.

The radiation detecting device illustrated at FIG. 8 can further include a logic circuit 185 disposed at the substrate 182. In accordance with a particular embodiment, the logic circuit 185 is electrically coupled to the radiation-detecting structure 184 such that it is capable of controlling the charge storage structures and performing certain operations, such as various operations associated with detecting the occurrence of a radiation event.

As such, it will be appreciated that the combination of the substrate 182, radiation-detecting structure 184, and logic circuit 185 can be part of the integrated circuit 183 overlying the base 181. Similarly, other electrical components (e.g., capacitors, diodes, etc.) not currently illustrated may be included in the device 18, and more particularly disposed at the substrate 182 for interaction with the logic circuit 185 and radiation-detecting structure 184.

The device 18 further includes a cover 186 overlying the radiation-detecting structure 184, and more particularly overlying the upper surface of the integrated circuit 183. The cover can provide protection from environmental factors, such as dust and the like that may damage the components of the integrated circuit 183. In accordance with a particular embodiment, the cover 186 can be a flexible material, and may include a polymer. In certain embodiments, the cover 186 may be mechanically coupled to a portion of the base 181. Still, in other embodiments, the cover 186 may be mechanically coupled to portions of the substrate 182.

In fact, according to one particular embodiment, the cover 186 can be a flexible circuit, having conductive busses and electrodes disposed therein for electrical connection to the integrated circuit 183. That is, according to one embodiment, the cover 186 can be an interposer capable of providing electrical connections between an upper surface of the integrated circuit 183 and external contact of the interposer. For example, cover 186 can include electrical connections or interconnects 1841 and 1842 extending from an upper surface of the cover 186 to an upper surface of the integrated circuit 183 for electrical connection to components within the integrated circuit 183, such as the radiation-detecting structure 184.

FIG. 8 includes a cross-sectional illustration of a device 19 including a plurality of radiation-detecting components in accordance with an embodiment. In particular, the device 19 includes a housing 190 and a plurality of radiation-detecting components 191, 192, and 193 (191-193) contained therein. Each of the plurality of radiation-detecting components 191-193 can be individual radiation-detecting structures as described in FIG. 1. Alternatively, the components 191-193 can be radiation-detecting devices including multiple radiation-detecting structures in accordance with embodiments herein. Notably, the components 191-193 can be stacked and aligned within the housing 190 such that they are suitably arranged to detect a radiation event with a higher probability.

According to one particular embodiment, each of the components 191-193 are semiconductor devices as described at FIG. 7 including a base, substrate, radiation-detecting structure at the substrate, and a cover. Such a design can incorporate multiple radiation-detecting structures, each radiation-detecting structure having an array of charge storage structures. Such a structure can be portable, but may further be mountable at strategic locations.

The size of the device 19 can vary depending upon the size of the radiation-detecting components 191-193. For example, the device 19 may be formed such that each of the components 191-193 includes an array of radiation-detecting structures at a semiconductor die. In other instances, the device 19 can be larger, such that each of the radiation-detecting components 191-193 includes a semiconductor wafer made of multiple semiconductor dice and therefore including multiple arrays of radiation-detecting structures.

As further illustrated in FIG. 8 and in accordance with a particular embodiment, the components 191-193 are aligned within the housing 190 such that the major surfaces of each of the substrates (or bases) are substantially aligned and define planes extending substantially parallel with each other. Moreover, in accordance with one embodiment, the radiation-detecting components 191-193 can be laterally spaced apart from each other and separated by material layers 196 and 197. In accordance with a particular embodiment, material layers 196 and 197 can include a thermalizing material. Utilization of a thermalizing material between the components 191-193 can improve the probability of detecting a radiation event.

FIG. 9A illustrates a portion of a radiation detecting device 20 that detects radiation. Specifically, the radiation-detecting device 20 includes an array 21 of charge storage structures 29, a reference module 22, a buffer 23, charge storage controller 24 (i.e., a digital signal processor), a timer module 25, and a control module 26. It will be appreciated that each of the charge storage structures 29 can be integrates as part of a radiating-detecting structure, such as structure 104 previously described, which can be associated with a transistor device, or other electronic device.

The device 20 represents an integrated circuit device, whereby the elements illustrated at FIG. 8 represent various devices integrated at a common substrate, such as a semiconductor substrate. Reference module 22 can provide a voltage reference signal to the array of charge storage structures 21, and more particularly can be a controllable digital signal reference module. The device further includes a control module 26 that can be used to control various portions of device 120 to determine a state of each of the charge storage structures 29. In one embodiment, the control module 26 provides control signals to the reference module 22 to determine whether or not a transistor associated with a specific storage structure 29 is in a conductive or non-conductive state for a specific read voltage applied at its control gate. By determining whether any one of the charge storage structures 29 is in a different read state than expected, a radiation event can be detected.

As further illustrated, the device 20 includes a control module 26 that can operate during a detect operation to load state information from each of the charge storage structures 29 into a buffer 23, which can be a memory array such as an SRAM, to allow for fast access. In other words, control information can be provided from a control module 26 to the buffer 23 and the array of charge storage structures 21 in order to provide state information of the charge storage structures 29 to the buffer 23. A charge storage controller 24 is connected to the array of charge storage structures 21 and the reference module 22 and can control an amount of charge stored at each one of the charge storage structures 29.

As indicated above, the digital radiation-detecting structure operates by modifying a charge at charge storage structures 29 within the array of charge storage structures 21 in response to a radiation event. In particular embodiments, the radiation-detecting structure is capable of detecting a radiation event in a mode of operation having a lower voltage than that of the controller 24. In certain embodiments, the radiation-detecting structure is capable of detecting a radiation event in a mode of operation having a lower voltage than that of the timer module 25. In more particular embodiments, the radiation-detecting structure is capable of operating and detecting a radiation event with no voltage across the device (i.e., the array of charge storage structures 21).

FIG. 9B illustrates a device 1010 that includes a radiation-detecting device and a radiation-insensitive device according to an embodiment. Specifically, the device 1010 includes a radiation-detecting device 1021 that includes an array of charge storage structures 29 as previously illustrated in FIG. 9A. The device 1010 further includes a radiation-insensitive device 1041 that is substantially unaffected by radiation events that affect the radiation-detecting structure 1021, including for example, interactions with neutrons. In particular, the radiation-insensitive device 1041 of FIG. 9B can include devices suitable for controlling operations of the device 1010 and storage of information such that functions of the device 1010 are substantially unaffected by radiation events. As illustrated, the radiation-insensitive device 1041 can include a counter module 1043 that is connected to a controller module 1045, and a memory array 1017 connected to the controller module 1045.

The radiation-insensitive device 1041 can include a memory array 1017 including radiation-insensitive charge storage structures 1018 that are substantially unresponsive to radiation. That is, the charge storage structures 1018 do not change states when exposed to radiation as compared to the charge storage structures 29, and therefore are capable of retaining stored information during radiation events. As such, in one embodiment, the memory array 1017 is a non-volatile memory array, for storing information suitable for operation of the device 1010. In a more particular embodiment, the memory array 1017 is a read-only-memory (ROM).

In certain instances, the radiation-insensitive charge storage structures 1018 can be charge storage structures having the same design and topology as the charge storage structures 29 within the radiation-detecting device 1021. However, the radiation-insensitive charge storage structures 1018, while having the same topology, can include at least one material that is different than the material within the charge storage structures 29. For example, the charge storage structures 29 can have a layer including a radiation-sensitive material, such as ¹⁰B, while a corresponding layer within the charge storage structures 1018 includes a different isotope of boron, such as ¹¹B. Notably, certain layers within the charge storage structures 29 and 1018 are intentionally manufactured to have a significantly different amounts of isotopes, such as ¹⁰B and ¹¹B, beyond variations attributable to naturally occurring phenomena or lack of manufacturing control. It will be appreciated that the use of different materials within the different charge storage structures is not limited to different isotopes of boron, or even different isotopes of the same element, and accordingly, the charge storage structures can include completely different elements, compounds, or materials.

Moreover, in accordance with a particular embodiment, the memory array 1017 can include a greater number of charge storage structures 1018 than the number of charge storage structures 29 within the radiation-detecting device 1021 (i.e., radiation-detecting memory array). That is, the memory array 1017 can store information suitable for operating the device 1010, while the radiation-detecting device 1021 includes charge storage structures 29 suitable for recording radiation events. Accordingly, for the purposes of quick read operations and rapid detection of radiation events, the radiation-detecting device 1021 may include fewer charge storage structures 29, especially when compared to certain conventional memory arrays, or even in comparison to the memory array 1017. For example, according to one embodiment, the radiation-detecting device 1021 includes not greater than about 1E8 charge storage structures 29 per cm². In other embodiments, the density of charge storage structures 29 within the radiation-detecting device 1021 can be less to reduce the duration of read operations, such as not greater than about 1E7, not greater than about 1E5, or even not greater than about 1E6 charge storage structures 29 per cm². According to one particular embodiment, the number of charge storage structures 29 is within a range between about 1E4 and 1E8 charge storage structures 29 per cm².

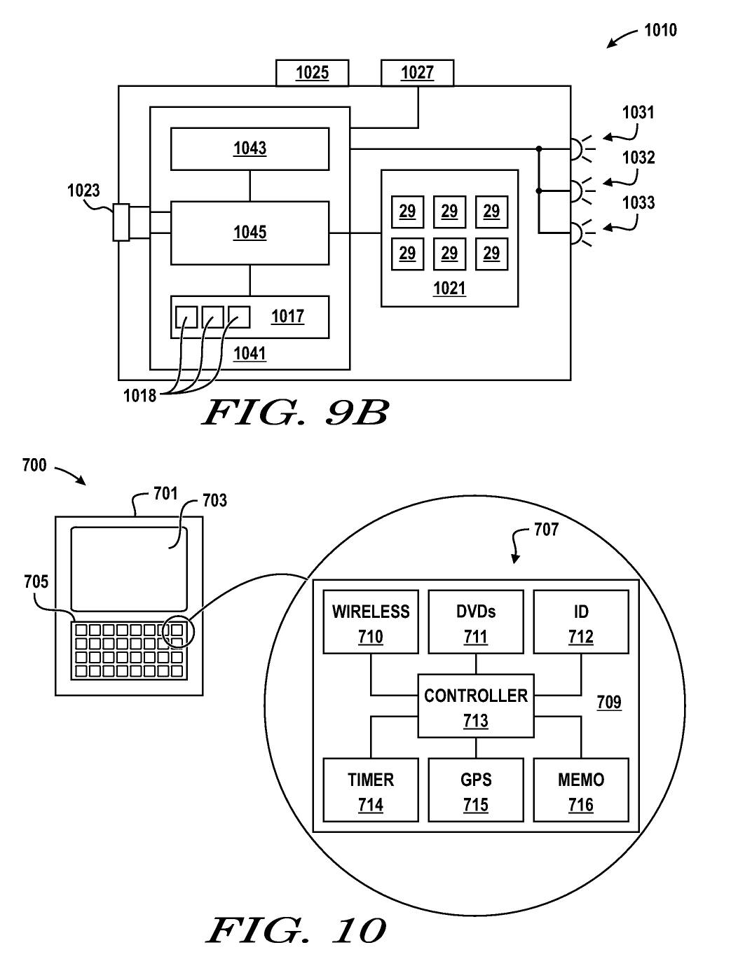

As illustrated, the device 1010 of FIG. 9B includes a control module (i.e., digital data processor) 1015 that is connected to the memory array 1017 and the counter module 1043. The control module 1015 can be used to control various portions of device 1010, and may be particularly used to facilitate read operations of the radiation-detecting device 1021 and detection of a radiation event. Generally, the control module has the same functions as previously described in accordance with the control module 26 of FIG. 10A.

The device 1010 can further include a counter module 1043 connected to the control module 1015. According to one embodiment, the counter 1013 can be a bit counter configured to count bits of the charge storage structures 29 within the radiation-detecting device 1021 having a certain state. For example, the counter 1013 can be configured to count bits of the charge storage structures 29 having a charge state associated with a radiation event, thereby facilitating a count of recorded radiation events.

The device 1010 further includes a port 1023 for access by external devices to the device 1010, and more particularly, external access to the radiation-insensitive structure 1011, the control module 1015, and the radiation-detecting device 1021. For example, the port 1023 can be universal serial bus (USB) port, serial peripheral interface (SPI) port, or the like. Certain external devices that may be suitable for connection of the device 1010 can include data storage devices for recording the contents of the radiation-detecting device 1021. In certain embodiments, the device 1010 can be connected to an electrical device via the port 1023 capable of sending the stored information to a remote monitoring station, via wireless communication, or alternatively to a web-based data storage and analysis center via web-based communication systems for world-wide, real-time mapping of the radiation-detecting structures.

For example, according to one particular embodiment, the device 1010 can be a portable memory device, like a thumb drive, that can be carried by an individual for recording radiation events. As will be appreciated, such portable memory devices generally include ports, such as USB ports for coupling to a computer or other such electronic device, for reading the device 1010 and storing the information contained on the device 1010. Such portable memory devices can be used by a variety of individuals in a variety of places. It will be appreciated that in the context of portable memory devices, such devices may not necessarily include certain components, such as the wireless transceiver 710, and as such may use wired communication system including for example the internet.

While the device 1010 of FIG. 9B has been illustrated as having a radiation-insensitive device 1041 including memory array 1017 separate from the charge storage structures 29 of the radiation-detecting device 1021, it will be appreciated that a single array may be formed including the radiation-insensitive charge storage structures 1018 and the charge storage structures 29 capable of detecting a radiation event. In such embodiments, the memory may be partitioned accordingly, such that a portion of the memory array includes radiation-insensitive charge storage structures 1018 and a different portion includes the radiation-sensitive charge storage structures 29.

It will further be appreciated that while certain elements of the device may not be illustrated, including for example, a reference module, buffer, controllers, and timer modules, the device 1010 can include these components. Moreover, other electrical components such as resistors, capacitors, and logic gates may be included within the device 1010.

As illustrated, the device 1010 further includes external interfaces 1025 and 1027 for user controlled operation of certain functions. For example, the external interface 1025 can be a button for turning the device 1010 on and off. In an alternative embodiment, the external interface 1025 can be a button for operating only the portion of the device 1010, including for example, the radiation-detecting device 1021 and the control module 1011 to control its operation. Such embodiments may be particularly advantageous when the device 1011 is part of a mobile device having other functions, such as a cell phone, personal assistant device, and the like, and the user desires only to operate the radiation-detecting device 1021.

As illustrated, the device 1010 includes an external interface 1027 for user control of certain operations. For example, in one embodiment, the external interface 1027 can be a reset button, for re-starting or re-booting the device 1010. As in other embodiments, the external interface 1027 can operate the entire device 1010 or portions of the device, which can be particularly useful when the device 1010 is part of another electronic device. In certain instances, a reset button may be suitable to reset the radiation-detecting device 1021, which can include performing erase and programming operations to set the charge storage structures 29 at a predetermined voltage. Such a function may be particularly useful after detecting a radiation event to assure that the charge storage structures 29 are properly reprogrammed to detect subsequent radiation events.

In accordance with another embodiment and as illustrated, the device 1010 can include indicators 1031, 1032, and 1033 (1031-1033) for providing the user with feedback on the state of the device 1010. For instance, in one embodiment, the indicators 1031-1033 are visual indicators, such as lamps or light emitting diodes (LEDs) providing the user with an indication of the state of the device, and more particularly the state of the radiation-detecting device 1021. For example, one of the indicators can be illuminated when no radiation event is detected (e.g., “all clear” signal). Another indicator can be illuminated when a radiation event has been detected. While, another indicator can be illuminated when an error has occurred, indicating a possible radiation event and prompting the user to proceed with certain operations, such as a reset and read operation. As will be appreciated, the indicators can have different colors.

As will also be appreciated, while not illustrated in the embodiment of FIG. 9B, the device 1010 can include an internal power source, such as a battery.

The radiation-detecting structures described herein are digital radiation-detection structures. In particular, the radiation-detecting structures can be charge storage structures and thus operable on a binary basis that are capable of recording an event as one of two values with reference to a threshold value. In particular, the presently disclosed structures are dissimilar from crystal-based detecting structures and detecting structures relying on compounds such as CdZnTe (CZT), HgI, PbI, or AlSb which record events as an analog signal having an infinite number of result values that have to be translated to a digital signal.

It will be appreciated that the embodiments of devices described herein can be used in certain applications, such as monitoring applications. Examples of monitoring applications include applications suitable for monitoring radiation, such as security applications, for example applications to monitor the presence of nuclear materials. According to one embodiment, any one of the various embodiments herein can be incorporated within mobile devices, including for example personal mobile devices, and more particularly electronic or non-electronic personal mobile devices. For example, electronic personal mobile devices can include digital assistant devices, cell phones, computers, portable memory devices (e.g., flash memory) and any other hand-held or portable electronic personal device. Non-electronic personal mobile devices can include articles of clothing and accessories, badges, purses, wallets, and the like.

FIG. 10 includes an illustration of a personal mobile device including a radiation-detecting device in accordance with an embodiment. The device 700 illustrated is generally an electronic mobile device having a housing 701 and a display 703 and a keypad 705 coupled to the housing. In accordance with a particular embodiment, the display 703 is a touch-responsive display capable of manipulation by the user to operate functions of the personal mobile device.

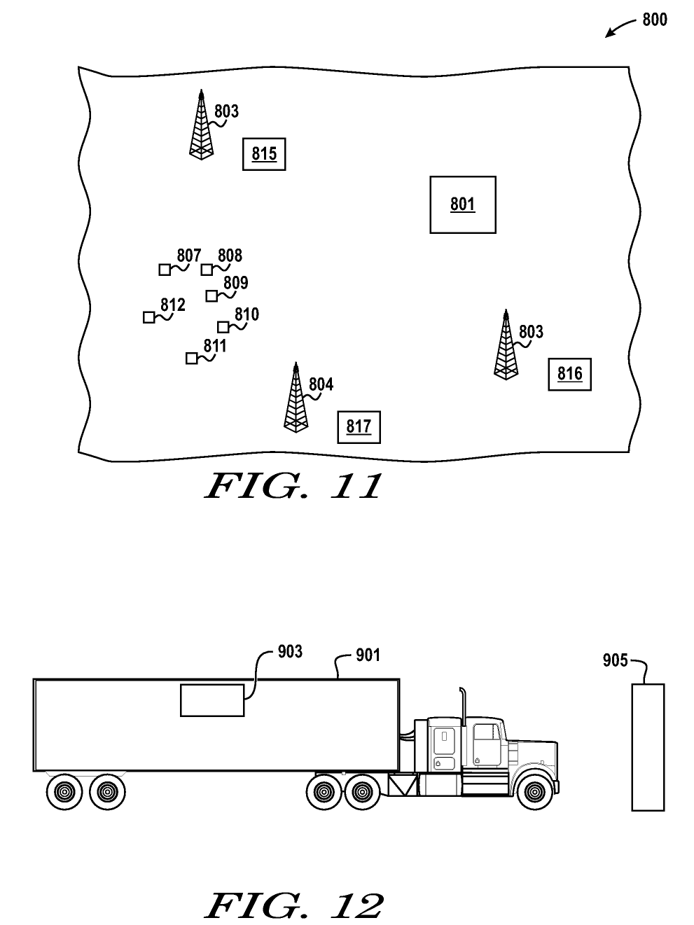

FIG. 11 further includes a magnified view of an internal portion of the device 700. In particular, the internal portion illustrates a portion of an integrated circuit 707 including a substrate 707 and having electronic devices 710, 711, 713, 714, 715, and 716 (710-716) at the substrate 707. The electronic devices 710-716 include a controller 713 (i.e., a digital data processor), a wireless transceiver 710 electrically coupled to the controller 713, a radiation-detecting structure 711 electrically coupled to the controller 713, and an identification portion 712 electrically coupled to the controller 713. The electronic devices further include a timer module 714 electrically coupled to the controller 713, a global positioning system (GPS) device 716 electrically coupled to the controller 713, and a microelectromechanical system device (MEMS) 715 electrically coupled to the controller 713. It will be appreciated that while the electronic devices 710-712 and 714-716 are illustrated as being coupled to the controller 713, any one of the electronic devices 710-712 and 714-716 can be directly electrically connected to each other.

It will be appreciated that the electronic devices 710-716 can be devices integrated onto a single semiconductor die, such that it forms a system on a chip. Alternatively, the device can include multiple semiconductor dice, wherein each dice can include different types and amounts of the electronic devices 710-716. According to one particular embodiment, the device 700 can include a system on a chip including a substrate, first programmable charge-storage structure including at least one radiation-detecting structure, and a controller. More particularly, such systems may further include a second charge-storage device, such as a memory array for storing data. Such memory arrays can be volatile or non-volatile memory.

The radiation-detecting device 711 can include any one of or a combination of the radiation-detecting structures described herein. Notably, the radiation-detecting device 711 can include a memory array that has an array of charge-storage structures, wherein a portion or all of the charge-storage structures can include a radiation-detecting structure.

According to one embodiment, the wireless transceiver 710 can be a transmitter and receiver capable of communicating with remote receivers and transmitters, such as using wireless communication networks. As will be appreciated, such wireless communication networks can include the use of internet enabled communication systems or radio frequency communication systems. The wireless transceiver 710 can be directly connected to the radiation-detecting device 711 and the controller 713 such that it the device 700 can receive and be programmed by signals generated from a remote monitoring system via remote transceivers. Likewise, the radiation-detecting device 711 can communicate information from the device 700 to the remote monitoring system via the remote transceivers.

The GPS device 716 can be included within the device 700 for global positioning of the device 700. The GPS device 716 can be electrically connected to the controller 713 and wireless transceiver 710 such that two-way communication between the device 700 and a remote monitoring center is possible. According to one particular embodiment, the GPS device 716 is capable of providing a user and remote systems with latitude, longitude, altitude, azimuth, and declination.

The MEMS device 715 can be electrically connected to the controller 713 as illustrated in FIG. 11. According to one embodiment, the MEMS device 715 can include a device capable of monitoring and reacting to the forces on the device 700. Some such suitable MEMS devices can include an accelerometer or gyroscope. In one embodiment, the MEMS device 715 can be activated by the controller 713 or the radiation-detection device 711 upon detection of a radiation event to determine the forces acting on the device 700 during the occurrence of the event. In accordance with another embodiment, the device 700 can include a nanoelectromechanical system (NEMS) device for the same purpose.

As illustrated in FIG. 10, the device 707 can include an identification portion 712 that may be electrically connected to the controller 713. Generally, the identification portion 712 can be used to communicate a unique identifier (e.g., a serial number or alphanumeric code) to other network devices through the wireless transceiver of the device or by other methods, such as backscatter technologies when in proximity to particular detectors. The identifier can be communicated to network devices such as remote wireless transceivers or remote data centers for identification of the device and tracking of the device. In certain instances, a unique identifier avoids tampering with certain devices, especially when the devices are also locatable within a region.

According to one embodiment, the identification portion 712 may be an electronic device capable of transmitting a signal identifying a unique identifier, such as an alphanumerical code. For example, in one particular embodiment, the identification portion 712 includes a transponder for communicating a signal using electromagnetic radiation. For example, certain identification portions 712 may include a radio frequency identification (RFID) device, a high frequency identification (HFID) device, a very high frequency identification (VHFID) device, a super high frequency identification (SHFID) device, a ultra-high frequency identification (UHFID) device, a extremely high frequency identification (EHFID) device, or even a low frequency identification (LFID) device. Moreover, the identification portion 712 can be an active, passive, or semi-passive device, thus in some cases (i.e., for active devices) utilizing a direct connection to the power source of the device 700, and in other cases (i.e., passive devices) not necessarily needing the devices power source.

In certain other embodiments, the identification portion 712 may not be an internal component. In more particular instances, the identification structure may not necessarily be an electronic component, for example, in certain instances, the identification structure can be indicia attached to the housing of the device 700. For example, in one particular embodiment, the identification portion 712 can be a bar code attached to an external portion of the housing 701 of the device 700.

In accordance with one embodiment, the timer module 714 can be electrically coupled to the radiation-detecting device 711 and includes a clock, and can be used to coordinate certain operations. For example, in one embodiment, the timer module 714 determines when to conduct a read operation of the digital radiation-detecting device 711. In a more particular embodiment, the timer module 714 can be set such that a read operation can be conducted a regular intervals to detect whether the radiation-detecting device 711 has detected a radiation event. As will be appreciated, the controller 713 may interface with the timer module 714 and the radiation-detecting device 711 to conduct the read operations. In fact, the read operation may be conducted as polling operation in which the timer module 714 sends a signal at regular intervals to the controller 713 and the controller initiates a read operation of the radiation-detecting device 711 to determine a state of the radiation-detecting device 711. Upon storing the data of the read operation the controller 713 can end the read operation until another signal is sent from the timer module 714.

It will be appreciated that data generated from conducting a read operation (i.e., read data) can be stored locally in a memory array contained within the device 700. Accordingly, the device 700 can include a memory array coupled to the controller 713. In one embodiment, the memory can be a non-volatile memory. Alternatively, the read data can be transmitted to a remote data storage center via the wireless transceiver 710. Moreover, it will be appreciated that the data of the read operation may be stored both locally and remotely. In such instances where the data is stored locally, the transmission of the data of the read operation can be done at regular intervals, such as once a day, once an hour, or at other intervals, such that the remote data storage center is updated at select intervals for real-time monitoring and contains up-to-date historical data from a device.

In yet another embodiment, the radiation-detecting device 711 can be electrically coupled to the wireless transceiver 710, and more particularly directly electrically connected to the wireless transceiver 710. Accordingly, data obtained from the read operation can be transmitted via the wireless transceiver 710 to a remote transmitter for storage and/or analysis at a remote data storage center. Moreover, in certain instances, a read operation may be initiated remotely. That is, a signal can be transmitted from a remote transmitter to the wireless transceiver 710 of the personal mobile device 700 initiating a read operation or a polling of the radiation-detecting device 711.

Other embodiments may utilize read operations of the radiation-detecting device 711 that are operator initiated. That is, the personal mobile device 700 can include hardware, firmware, or software capable of providing the operator with control of conducting read operations for detection of radiation events recorded by the radiation-detecting device 711. For example, in certain instances the operator can program the device to conduct read operations of the radiation-detecting device at regular intervals. Alternatively, the operator may choose to conduct random or operator-timed read operations to poll the radiation-detecting device 711.

In the event that a digital radiation-detecting device has recorded a radiation event, that is a change in the charge state of the digital radiation-detecting device, the controller can be programmed to conduct another read operation. According to one embodiment, the subsequent read operation may be conducted immediately after the initial read operation wherein a positive radiation event was detected. A subsequent read operation may facilitates a determination of the veracity of the first radiation event detected. That is, immediate subsequent read operations may help determine if the first event was a random event, such as a solar-based radiation event, or whether the radiating source was terrestrial-based. For example, if a second subsequent read operation is performed and a positive radiation event is again recorded on the device, the likelihood of a random event is dramatically decreased.

Alternatively, the timer module 714 and controller 713 can be programmed to change the interval at which it performs read operations, for example, the duration between read operations may be shortened such that it can readily detect whether the digital radiation-detecting device has been affected by a second radiation event in the shortened duration indicating a radiation source in close proximity to the device 700. For example, in one embodiment, the timer module 714 and controller 713 can be programmed to conduct multiple read operations in rapid succession such that the device 700 operates under an active monitoring protocol. The duration of the active monitoring protocol can be programmed, such that the device 700 operates under the protocol for a duration of at least a minute. In other instances, the duration of the active monitoring protocol may be greater, for example at least a couple of minutes, or even up to an hour.

After conducting a read operation, and more particularly in response to detection of a radiation event by reading the radiation-detection device, the device 700 may generate an alert signal. In accordance with one embodiment, the alert signal is sent to the operator of the device via an audio alert signal, visual alert signal, or a combination thereof. In one particular embodiment, the alert signal is sent to the operator in the form of a message, such as a text message, page, or an email. It will be appreciated that an alert signal may be generated after a single detected radiation event, or after the detection of two radiation events having a predetermined temporal relationship (i.e., two detected radiation events within a given time).

According to an alternative embodiment, the alert signal may also be sent to a remote data storage center or monitoring center via the wireless transceiver 710 and remote transmitters. As will be appreciated, the alert signal can be sent to multiple sources, including for example the device operator, the remote data storage center, other users in the vicinity.

The sources selected to receive an alert signal can be chosen by the operator of the device, or alternatively, can be selected by the data storage center (e.g., a clearing house or monitoring center). In fact, according to one particular embodiment, upon receiving an alert signal from a user, the data storage center can select from other devices in the vicinity having radiation-detection devices, send a signal to such devices to conduct a read operation, and send the result of the read operation back to the data storage center. Such a polling operation enables the monitoring center to determine if the detected radiation event is a random event, such as a solar event, a false positive, or a terrestrial-based radiation source. Additionally, polling of other devices in a select vicinity may further aid location of a radiating source.

Referring briefly to FIG. 11, an illustration of a geographic region including a communication network for managing data of radiation-detecting devices is provided. As illustrated, the region 800 includes radiation-detecting devices 807, 808, 809, 810, 811, and 812 (807-812), remote wireless transceivers 803, 804, and 804 (803-805), and a data storage center 801 for monitoring the radiation-detecting devices 807-812 within the region 800. As described herein, each of the radiation-detecting devices 807-812 can have two-way communication with the data storage center 801 via the remote wireless transceivers 803-805.

Additionally, the region 800 can further include remote data substations 815, 816, and 817 (815-817) for buffering data and storage of data from the radiation-detecting devices or the data storage center 801. As illustrated, each of the remote data substations 815-817 can be located in proximity to the remote wireless transceivers 803-805, and in particular instances, may be directly connected to the remote wireless transceivers 803-805. According to one embodiment, the remote data substations 815-817 can have long-term data storage capabilities that may be accessed by the data storage center 801.

In certain embodiments, the communications network can include a great number of remote wireless substations such that real-time monitoring and data transfer between the radiation-detecting devices can occur. In one particular embodiment, the remote wireless substations can be strategically located, such as at street corners or busy pedestrian thoroughfares for monitoring of the mobile devices having the radiation-detecting devices. The remote wireless substations 815-817 can have two-way communications with any devices passing within a certain radius and can poll the radiation-detecting devices within the devices to determine if a radiation event has occurred.

Additional data can be gathered from nearby devices, including polling the devices for the time at which a detected radiation event occurred, position of the device upon detecting the event, and the like. Moreover, upon a remote wireless substation detecting a radiation event recorded in a nearby radiation-detecting device, the data recorded during the event can be sent from the remote wireless substation to the data storage center. The data storage center can initiate a read operation of radiation detecting devices within a select geographic proximity to confirm detection of a same or similar radiation event for real-time monitoring. Additionally, the data storage center can also send a signal to one or more remote wireless substations within a select geographic proximity to conduct a scan of all radiation-detecting devices within the vicinity for evidence of radiation events.

According to certain embodiments herein, the data storage center 801 can monitor data, store data, program and control the operations of radiation-detecting devices within the region 800. In cases where a radiation event is detected by a radiation-detecting device, for example the radiation-detecting device 807, the alert signal can be sent to the operator the radiation-detecting device 807 and the data storage center 801. Upon receiving the alert signal, the data storage center 801 can send a signal to other radiation-detecting devices, for example radiation-detecting devices 808-812 within a select proximity to the radiation detecting device 807 and ask them to perform a read operation of the radiation-detecting devices to determine if a radiation event has been detected by devices in the area. Locating other radiation-detecting devices 808-812 within the region 800 can be accomplished using GPS modules that may be integrated in each of the devices, or alternatively, through triangulation using remote wireless transceivers 803-805.

As described herein, certain devices can include identification portions in addition to the radiation-detecting device. The identification portions can be in communication with the network devices such as the data storage center 801 and data storage substations 815-817. For example, when an alert signal is sent from a device containing a radiation-detecting device, the signal may further contain an identifier provided by the identification portion for accurate identification and recording of the device generating the alert signal.

While the description has been generally directed to mobile devices, such as the electronic personal mobile device illustrated in FIG. 10, radiation-detecting devices can be incorporated into other mobile devices that may not necessarily be personal mobile devices. According to one embodiment, the radiation-detecting devices can be incorporated into transportation vehicles. Transportation vehicles can include land-based transportation vehicles, water-based transportation vehicles, and air-based transportation vehicles. In one embodiment, the transportation vehicles can include piloted vehicles, such as automobiles, airplanes, or boats. According to alternative embodiments, the transportation vehicles can be remote controlled vehicles, such as drones, or computer guided vehicles.

FIG. 12 includes an illustration of a transportation vehicle including a radiation-detecting device in accordance with an embodiment. As illustrated, the transportation vehicle 901 can be a truck that includes a radiation-detecting device 903 coupled to the transportation vehicle. The radiation-detecting device can include structures described in accordance with the embodiments herein.

In accordance with a particular embodiment, the radiation-detecting device can include those electronic devices described in accordance with the embodiment of FIG. 10, notably including a wireless transceiver, a controller, a timer module, an identification portion, a global positioning system, and a MEMS device. More particularly however, given the size of transportation vehicles, certain embodiments may utilize devices having greater sizes, such as those described in accordance with FIGS. 7 and 8. That is, such devices can include substrates having an array of charge storage structures including the radiation-detecting devices, and more particularly may include a plurality of substrates each including an array of charge storage structures including the radiation-detecting devices. In such embodiments, it may be particularly suitable for the devices to include a plurality of substrates or semiconductor dice, for example at least 5 semiconductor dice as described herein.

Moreover, such radiation-detecting devices are capable of communicating on a network such as that described in FIG. 11. In particular, each of the detectors 905 may be capable of wireless two-way communication with data storage centers, remote data substations, and remote wireless transceivers. In other certain embodiments, the detectors 905 can form an independent and secure wireless network having encryption capabilities and exchanging information without the use of other wireless communications networks, such as those currently used to service cell phones.

Alternatively, devices incorporating the radiation-detecting devices attached to transportation vehicles can use a different communication network. In particular, the communication network can include detectors 905 that are set in strategic locations along thoroughfares used by the transportation vehicles 901. For example, detectors 905 can be set at docks of major import and export facilities, airports, and along roadways such as highways, express ways, toll ways, and the like. More particularly, detectors 905 can be set a regular intervals at strategic locations surrounding metropolitan areas.

The detector 905 can include electronic components suitable for communicating with and conducting a read operation of the radiation-detecting devices to determine if a radiation event has been detected. According to one embodiment, the detector 905 can include electronic components such as a controller, a wireless transceiver, a electromagnetic frequency identification detector (e.g., RFID detector), memory, timer modules, global positioning systems, and the like.

According to an alternative embodiment, radiation-detecting devices may not necessarily be placed on the transportation vehicles or transported cargo, and instead a system of stationary monitoring applications can be used. For example, the devices and methods described herein can be used for monitoring radiation at stationary locations. For example, the stationary location could at a nuclear reactor site, inside of a building, outside of a building, along the thoroughfares described herein, or any other locations where it would be useful to determine whether or not a neutron source has been detected.

The embodiments herein describe devices capable of imaging and more particularly, devices capable of detecting the presence of certain types of radiation and communication networks for monitoring such devices. Certain publications have suggested the use of radiation detecting mechanisms in certain devices (See, for example, U.S. Pat. No. 7,148,484), however such disclosures have been directed to the use of crystalline or semiconductor components that are generally analog devices that are not well-suited for interfacing with digital components. That is, such analog components require additional electronics for conversion of the analog signal to a digital signal for processing. Moreover, such devices are larger and cumbersome devices, that may not be internally integrated within the device and typically require external coupling to the device through a serial port. Furthermore, such devices typically require a significant power source, and power to the component to be operable and detect an event. Such detectors can drain the limited power supply of mobile device.

In contrast, the present application is directed to small, digital radiation-detecting devices capable of integration with existing mobile devices, electronic or non-electronic, transportation vehicles, or as stationary monitoring platforms. In particular, the present application discloses mobile devices having certain combinations of features including digital radiation-detecting devices, GPS, identification modules, time modules, controllers, and other components for real-time monitoring and data collection. Additionally, the present application discloses features of communication networks capable of interfacing and communicating with such devices incorporating the digital radiation-detecting devices. In particular, such networks can utilize a combination of features including for example, data storage centers, data storage substations, proximity data collection, and remote detectors strategically located along key thoroughfares.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

What is claimed is:

1. An article comprising:
a mobile device including:
a housing:
a wireless signal transceiver contained within the housing; and
a radiation-detecting structure comprising a charge storage structure contained within the housing to detect radiation.

2. The article of claim 1, wherein the radiation-detecting structure is a neutron-detecting structure.

3. The article of claim 1, further comprising a timer module coupled to the radiation-detecting structure to determine when to conduct a read operation to determine a state of the radiation-detecting structure.

4. The article of claim 3, wherein upon conducting the read operation, read data is generated and transmitted to a remote transmitter.

5. The article of claim 4, wherein an alert signal is generated in response to the read operation.

6. The article of claim 5, wherein the alert signal is transmitted to a communications network.

7. The article of claim 1, further comprising a microelectromechanical system (MEMS) electrically coupled to the radiation-detecting structure.

8. The article of claim 7, wherein the MEMS is an accelerometer.

9. The article of claim 1, wherein the housing is coupled to a transportation vehicle.

10. The article of claim 1, further comprising a digital data processor electrically coupled to the radiation-detecting structure.

11. The article of claim 10, further comprising a radiation-insensitive charge storage structure coupled to the digital data processor.

12. The article of claim 11, wherein the radiation-insensitive charge storage structure and the radiation-detecting structure are part of a same memory array.

13. The article of claim 11, wherein the radiation-detecting structure comprises a same design as the radiation-insensitive charge storage structure.

14. The article of claim 13, wherein the radiation-detecting structure comprises a radiation-sensitive layer including a material different than a material within a corresponding layer of the radiation-insensitive charge storage structure.

15. The article of claim 14, wherein the radiation-detecting structure comprises ¹⁰B and the radiation-insensitive charge storage structure comprises ¹¹B.

16. An article comprising:
a personal mobile device comprising:
a housing;
a wireless signal transceiver contained within the housing;
a substrate contained within the housing; and
a charge storage structure disposed at the substrate within the housing comprising a radiation-reactive material, wherein the charge storage structure is electrically connected to the wireless signal transceiver.

17. The article of claim 16, wherein the radiation-reactive material comprises an amorphous phase.

18. The article of claim 16, wherein the radiation-reactive material comprises an element selected from the group of elements consisting of ¹⁰B, ⁶Li, ¹¹³Cd, and ¹⁵⁷Gd.

19. The article of claim 16, further comprising a thermalizing material overlying the charge storage structure.

20. An article comprising:
a mobile device including:
a housing:
a wireless signal transceiver contained within the housing; and
a radiation-detecting structure comprising ¹⁰B to detect radiation.
